(19) United States
(12) Patent Application Publication
(10) Pub. No.: US 2004/0200333 A1
(43) Pub. Date: Oct. 14, 2004

(54) 360 Degree ball lock groove for a tool assembly

(76) Inventors: David E. Seeley, Lincoln, NE (US); James E. Lee, Seward, NE (US)

Correspondence Address: Gordon K. Harris, Harness, Dickey & Pierce. P.L.C., P.O. Box 828, Bloomfield Hills, MI, 48303, US

(21) Appl. No.: 10/413,086

(22) Filed: Apr. 14, 2003

(51) Int. Cl. B26F 1/14

(52) U.S. Cl. 83/698.91; 83/684

(57) ABSTRACT

A tool assembly is provided comprising a tool retainer having a bore formed therein and a tool disposed within the bore and extending outwardly from the tool retainer. The tool includes a radial groove formed at an end of the tool disposed within the bore that extends around the entire circumference of the tool. A locking mechanism is disposed within the bore and includes a ball biased into the groove for locking the tool to the tool retainer. The groove has a sloped face terminating in a cup portion. The cup portion and groove are shaped to receive the ball. The locking mechanism includes a passage extending from a side of the bore for receiving the ball. The passage is formed at a slight angle to the sloped face of the groove.

### FIELD OF THE INVENTION

The present invention relates to tool assemblies and more particularly to a 360 degree ball lock groove for a tool assembly.

### BACKGROUND OF THE INVENTION

Ball lock tool retainers have been known in the art for some time. A typical ball lock tool retainer is shown in U.S. Pat. No. 6,324,768. A tool is fitted within a retainer and held in place by a ball lock. The ball lock consists of a ball and spring that engage a teardrop shaped depression formed in a side of the tool. For the tool to be locked within the retainer, the tool must be radially positioned such that the teardrop depression properly aligns with the ball of the retainer. Where the tool does not require a certain orientation with respect to the assembly or workpiece, for example with circular tools such as a punch, a die block, a form punch, or a form ring, radially aligning the tool with the retainer is an unnecessary and awkward step.

Accordingly, it is an object of the present invention to provide the art with a tool assembly having a 360 degree ball lock groove such that radial alignment of a tool with respect to a tool retainer is unnecessary.

### SUMMARY OF THE INVENTION

A tool assembly is provided comprising a tool retainer having a bore formed therein and a tool disposed within the bore and extending outwardly from the tool retainer. The tool includes a radial groove formed at an end of the tool disposed within the bore that extends around the entire circumference of the tool. A locking mechanism is disposed within the bore and includes a ball biased into the groove for locking the tool to the tool retainer. The groove has a sloped face terminating in a cup portion. The cup portion and groove are shaped to receive the ball. The locking mechanism includes a passage extending from a side of the bore for receiving the ball. The passage is formed at a slight angle to the sloped face of the groove. A release hole extends from a surface of the retaining tool to the passage parallel to the bore and is sized to receive a release tool. The release tool engages the ball to urge the ball within the passage away from the groove, thereby unlocking the tool from the retainer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a tool having a 360 degree ball lock groove according to the principles of the present invention;

FIG. 2 is a top view of the tool having a 360 degree ball lock groove;

FIG. 3 is a side sectional view of a tool assembly having the tool with a 360 degree ball lock groove in an unlocked state;

FIG. 4 is a side sectional view of the tool assembly having the tool with a 360 degree ball lock groove in a locked state; and

FIG. 5 is a side view of a release tool for use with the tool assembly according to the principles of the present invention.

### DETAILED DESCRIPTION OF THE PREFERRED EMBODIMENTS

The following description of the preferred embodiments is merely exemplary in nature and is in no way intended to limit the invention, its application, or uses.

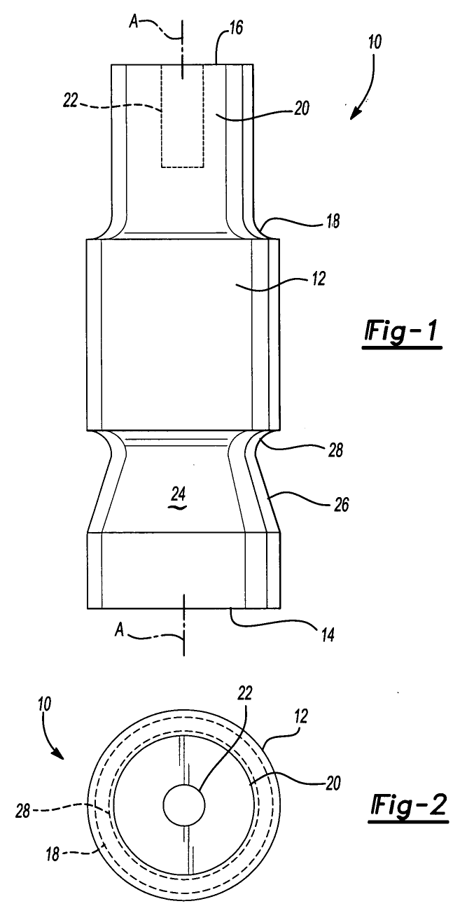

Referring generally to FIGS. 1 and 2, a tool constructed in accordance with the teachings of the present invention is generally indicated by reference numeral 10. The tool 10 includes a body 12 having a base 14 and a tip 16. In the particular example provided, the tool 10 is illustrated as a sheet metal punch. However, it is to be understood that the tool 10 may be any conventional tool piece, for example, a punch, a die block, a form punch, or a form ring.

The body 12 is generally cylindrical along a longitudinal axis A-A. The base 14 forms a flat surface on the tool 10 opposite the tip 16. A curved span 18 formed in the body leads to a head portion 20 having a diameter less than the diameter of the body 12. The tip 16 is shown to include a bore 22 formed therein extending down into the head portion 20. The bore 22 is sized to receive a tool element, not shown, to facilitate removal or installation of the tool element. However, various other tip and tool element designs may also be used with the present invention.

A lock groove 24 is formed in the body 12 near the base 14 and extends fully around the outside circumference of the tool 10. The lock groove 24 may be turned, milled, or otherwise formed in the tool 10. The lock groove 24 includes a sloped surface 26 angled with respect to the axis A-A of the tool 10. The sloped surface 26 extends from the outer surface of the body 12 near the base 14 into the body 12 and terminates at a radius curve 28. The radius curve 28 is defined by a portion of the outer surface of a sphere. The radius curve 28 connects the sloped surface 26 to the outer radius of the body 12.

Referring now to FIG. 3, a retainer for the tool 10 is generally indicated by reference numeral 30. The retainer 30 includes a bore 32 sized to receive the tool 10 and a backing plate 34 at an end of the bore 32. The backing plate 34 provides a support for the tool 10, as will be described in greater detail below. A hollow passage 36 extends from an inner surface of the bore 32 into the retainer 30 and ends at the backing plate 34.

The passage 36 is angled with respect to the longitudinal axis A-A of the tool 10 and at an angle to that of the sloped surface 26 of the tool 10. When the tool 10 is disposed within the bore 32, the passage 36 aligns with the sloped surface 26 of the tool to form a connected single surface. However, the angle between that of the passage 36 and the sloped surface 26 is such that the distance between the inner surface of the passage 36 and the sloped surface 26 decreases in the direction of the radius curve 28 of the tool 10.

A ball 38 is mounted within the passage 36. A biasing member 40, a spring in the particular example provided, is disposed between the backing plate 34 and the ball 38 and biases the ball 38 along the passage 36 towards the bore 32. A release hole 42 extends from the outer surface of the retainer 30 into the passage 36 parallel to the longitudinal axis of the bore 32. The release hole 42 is sized to receive a hand-held release tool. In the particular example provided, the hand-held release tool is illustrated as a conventional pin punch 44, as best seen in FIG. 5. The pin punch 44 includes an “L” shaped grip 46 and an arm 48 extending therefrom. The arm 48 terminates in a head 50. Alternatively, the hand-held release tool could be a wire having a gauge less than the diameter of the release hole 42, or any other rigid member capable of fitting within the release hole 42.

Referring again to FIG. 3, the loading of the tool 10 within the retainer 30 will now be described. First, the pin punch 44 is inserted into the release hole 42 such that the head 50 engages the ball 38. The ball 38 is then forced against the spring 40 down into the passage 36. At this point, the tool 10 may be inserted into the bore 32 until the base 14 engages the backing plate 34. When the tool 10 is inserted into the bore 32, the sloped surface 26 aligns with the inner surface of the passage 36 at a slight angle, as noted above.

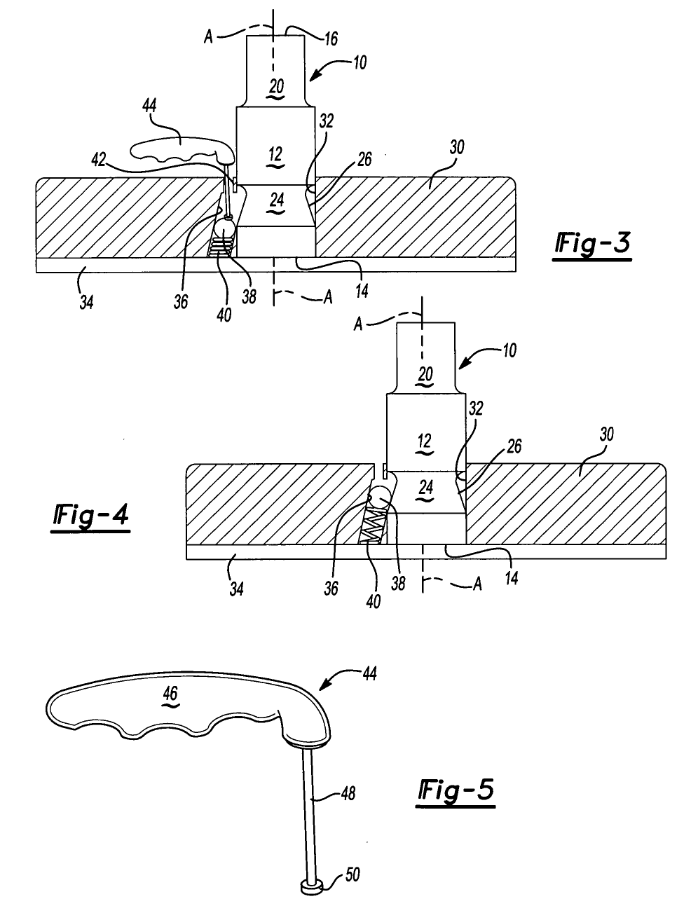

With reference to FIG. 4, removal of the pin punch 44 allows the spring 40 to urge the ball 38 along the passage 36 until such time as it engages both the inner surface of the passage 36 and the sloped surface 26 of the tool 10. With the spring 40 urging the ball 38 towards the radius corner 28, the slight angle difference between the sloped surface 26 and the inner surface of the passage 36 causes the ball 38 to wedge itself between the inner surface of the passage 36 and the sloped surface 26. In this locked position, the ball 38 prevents removal of the tool 10 from the retainer 30. Moreover, the tool 10 need not be radially aligned with the passage 36 since in any radial alignment the sloped surface 26 will align with the inner surface of the passage 36 and allow the ball 38 to lock the tool 10 to the retainer 30.

The description of the invention is merely exemplary in nature and, thus, variations that do not depart from the gist of the invention are intended to be within the scope of the invention. Such variations are not to be regarded as a departure from the spirit and scope of the invention.

1. A tool having a 360 degree ball lock groove adapted to be received within a tool holder and locked by a ball and spring, the tool comprising:
a substantially cylindrical body having a base and a tip;
a 360 degree groove formed around the circumference of said body proximate to said base, said 360 degree groove having a sloped face terminating in a radius corner having a surface defined by a portion of the surface of a sphere and adapted to receive the ball of the tool holder to lock the tool to the tool holder.

2. (Cancelled)

3. The tool having a 360 degree ball lock groove of claim 1, wherein said sloped face is adapted to receive the ball of the tool holder.

4. The tool having a 360 degree ball lock groove of claim 1, wherein said groove is formed into said tool by milling.

5. The tool having a 360 degree ball lock groove of claim 1, wherein said groove is formed into said tool by turning.

6. The tool having a 360 degree ball lock groove of claim 1, wherein said tool is a punch.

7. A tool assembly comprising:
a tool retainer having a bore formed therein;
a tool disposed within said bore and extending outwardly from said tool retainer, said tool having a 360 degree groove formed at an end thereof disposed within said bore, said 360 degree groove having a sloped face terminating in a radius curve; and
a locking mechanism disposed within said bore including a ball biased into said 360 degree groove for locking said tool to said tool retainer.

8. The tool assembly of claim 7, wherein, said sloped face is shaped to receive said ball.

9. The tool assembly of claim 7, wherein said locking mechanism includes a passage extending from a side of said bore for receiving said ball, said passage formed at an angle to said sloped face of said groove.

10. The tool assembly of claim 9, wherein said locking mechanism further includes a release hole extending from a surface of said retaining tool to said passage parallel to said bore for receiving a release tool, said release tool engagable with said ball to urge said ball within said passage away from said groove, thereby unlocking said tool.

11. The tool assembly of claim 10, wherein said ball is biased by a spring disposed within said passage.

12. The tool assembly of claim 7, further comprising a backing plate mounted at a base of said bore, said backing plate abutting the end of said tool disposed within said bore.

13. The tool assembly of claim 7, wherein said groove is formed into said tool by milling.

14. The tool assembly of claim 7, wherein said groove is formed into said tool by turning.

15. The tool assembly of claim 7, wherein said tool is a punch.
